(19) United States
(12) Patent Application Publication
(10) Pub. No.: US 2022/0125014 A1
(43) Pub. Date: Apr. 28, 2022

(54) METHOD AND ASSEMBLY FOR MODIFYING HOUSEHOLD PET BEHAVIOR

(71) Applicant: Angela Suzanne Juberian, Inver Grove Heights, MN (US)

(72) Inventor: Angela Suzanne Juberian, Inver Grove Heights, MN (US)

(21) Appl. No.: 17/079,106

(22) Filed: Oct. 23, 2020

(51) Int. Cl. A01K 15/02

(52) U.S. Cl. CPC A01K 15/02

(57) ABSTRACT

A method and assembly for modifying household pet behavior includes generally comprising placing together in a room a plurality of living space articles such that the room is defined as a faux living space. The living space articles include furniture and the room is closable such that a pet positioned within the room cannot exit the room. Thereafter, a household pet brought into the room and is allowed to wonder, i.e. essentially live, within the room. The household pet activity within the room is monitored and corrective teaching is applied to the household pet when the household pet engages in impermissible behavior.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to household pet training methods and more particularly pertains to a new household pet training method for behavior modification of a household pet within an area that conditions the household pet to be prepared to live in an actual human living space. To this end the method utilizes a faux living space which has the appearance of an actual livable space but is only a superficial approximation of the living space. A person's pet, such as for example a canine, is trained within this area for behaviors including housetraining, jumping onto furniture, and the like so that when the pet is placed in its owner's home, the pet will exhibit the modified behavior due to the spatial conditioning the pet will associate with the training area. Essentially, the pet will be trained within an area resembling a home so that the pet exhibits appropriate and idealistic behavior within an actual home.

### (2) Description of Related Art Including Information Disclosed Under 37 CFR 1.97 and 1.98

The prior art relates to household pet training methods which teach pets within training areas that do not resemble a home or living space. As such, while training can be somewhat effective, there is less of an association for the pet between indoor and outdoor acceptable behaviors. Prior art teachings further include household pet training wherein the pets are trained within their actual living environment. This limits the amount of time that a trainer can work with a pet and can become more difficult due to interference by the owner of the pet.

### BRIEF SUMMARY OF THE INVENTION

An embodiment of the disclosure meets the needs presented above by generally comprising placing together in a room a plurality of living space articles such that the room is defined as a faux living space. The living space articles include furniture and the room is closable such that a pet positioned within the room cannot exit the room. Thereafter, a household pet brought into the room and is allowed to wonder, i.e. essentially live, within the room. The household pet activity within the room is monitored and corrective, corresponsive teaching is applied to the household pet when the household pet engages in impermissible behavior.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view schematic view of a method and assembly for modifying household pet behavior according to an embodiment of the disclosure.

FIG. 2 is a front view of an embodiment of the disclosure.

FIG. 3 is a front view of an embodiment of the disclosure.

### DETAILED DESCRIPTION OF THE INVENTION

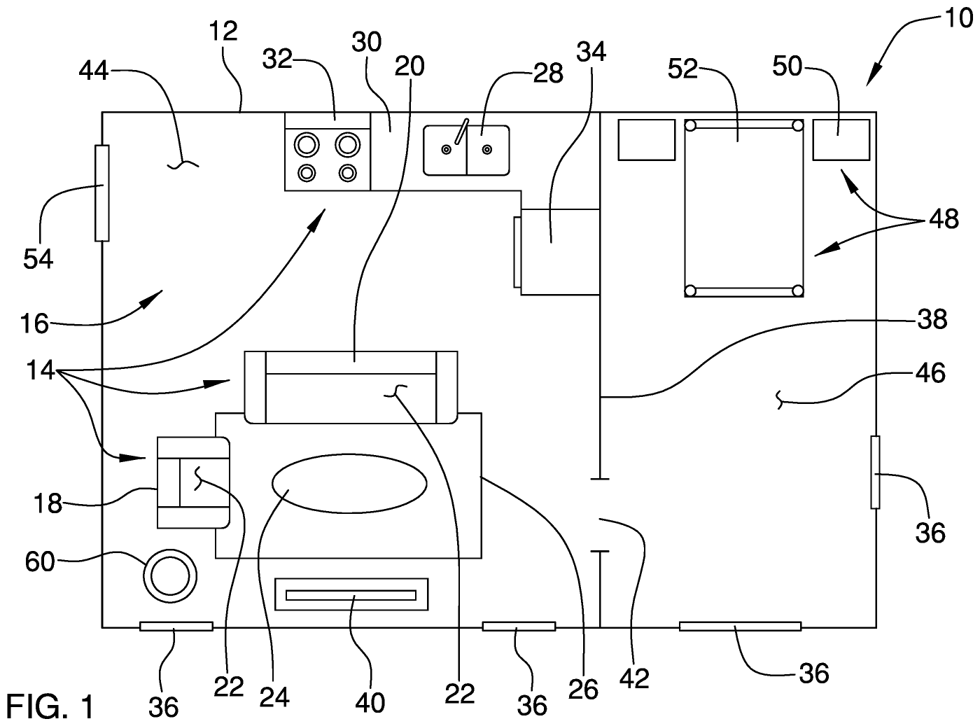

With reference now to the drawings, and in particular to FIGS. 1 through 3 thereof, a new household pet training method embodying the principles and concepts of an embodiment of the disclosure and generally designated by the reference numeral 10 will be described.

As best illustrated in FIGS. 1 through 3, the method and assembly 10 for modifying household pet behavior generally comprises creating an environment that is reminiscent of a living space within a dwelling to environmentally condition a household pet such as a canine or other pet to being within a living space. The goal of the method in particular is that by conditioning a pet to understand that they are within a living space, their behavior will automatically adapt to a specific hierarchy of allowed actions. For example, an owner of a household pet may determine that they do not want their pet to sit on a chair or sofa, or may be interested in housetraining the pet to prevent urination or defecation inside. While some pets may behave generally, or may behave while an owner is present, the pet may do such things as jump onto furniture or urinate on a rug when left alone. The method overcomes these tendencies by creating an environment that would appear to be very similar to a room being lived in by a person, but is staged to allow for training within a setting where the pet may exhibit poor behaviors without damaging an owner's property. This method is not limited to canines and may be used with other animals retained as household pets that are free to roam the interior of the dwelling and therefore may include, for example, felines, rabbits, pigs, other small livestock, etc. Moreover, the method may be utilized not only with newly owned pets but also previously owned pets, and currently owned pets which have behavioral problems.

To this end, the method requires the placing together in a room 12 a plurality of living space articles 14 such that the room 12 is defined as a faux living space 16. Specifically, living space articles 14 within the faux living space 16 includes furniture. While all types of furniture may be included, the furniture of greatest usage will include that upon which a human may be seated. Thus, the furniture will usually comprise at least one a chair 18 and one of a sofa 20 configured for seating a person—though only a single chair 18 or sofa 20 is needed. The chair 18 and the sofa 20 each have an upper side 22 comprising a fabric and the fabric may be comprised of any conventional fabric or leather including synthetic versions thereof. The living space articles 14 may further includes at least one table 24, such as a conventional coffee table, having a height is less than 24.0 inches. Other living space articles 14 may be included such as at least one rug 26 positioned on a floor of the room 12, to determine whether the pet is prone to lay upon or urinate on the rug 26. The room 12 may further be furnished with decorations such as wall coverings, paintings and the like, a kitchen including a sink 28, countertops/cabinets 30, stove 32 and refrigerator 34, and any other appliances such as televisions 40, computers and the like. All appliances, while they may be real, will typically be faux as the room 12 will not be livable for a human and may not typically include, for example, plumbing and cabinets would most often be without workable drawers.

While the room 12 may include plumbing and workable appliances and cabinets, it would be financially prohibitive as the room 12 would not be suitable for human living but only used as a staging area for household pet training. The room 12 may further include windows 36 both for natural light and the ability to open the windows 36 as needed for airing out the room 12 and for training the household pet how to become accustomed to outside noise which might otherwise cause excessive barking and stress to the pet. Articles may be added which create noise within the room 12 such as, for example, a vacuum cleaner, and odors may be introduced as well particularly if it is noted that a pet is particular sensitive to certain odors.

One or more sectional walls 38 may be positioned in the room 12 to create other faux living spaces such as, in particular, a bedroom. The sectional wall 38 will have an opening or doorway 42 therein to allow passage between a primary room 44 having living space articles 14 positioned therein and a secondary space 46 having sleeping articles 48 positioned therein. The sleeping articles 48 may include anything typically found in a bedroom including nightstands 50 but in particular will include a bed 52 to determine if the pet can be trained to prevent the pet from jumping onto the bed 52. The doorway 42 may or may not include a door.

The room 12 will be closable with a door 54 such that a pet positioned the room 12 cannot exit the room 12. This will allow a trainer to leave the pet in the room and then observe the pet either through one-way mirrors, small openings in walls, or cameras mounted in the room 12. By leaving the pet alone without supervision, the trainer can determine initially what type of training is needed and later whether or not the training is properly progressing.

Additional doors and rooms may be added as desired. For example, a bathroom including a toilet may be added which further introduces different types of flooring. Other elements of a typical household may include plants, small caged animals, fish aquariums, decorations which may include seasonal decorations, and litterboxes. Food may be placed within the room 12 to entice an animal to attempt to acquire the food. Also, furniture, such as the bed 52 or other furnishings may be swapped out or be customizable to adjust their height to better emulate a pet owner's own furniture or room layout.

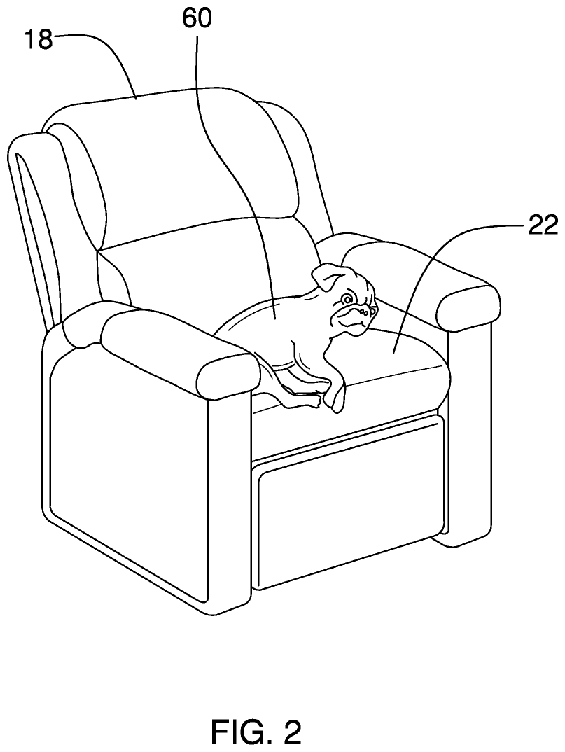

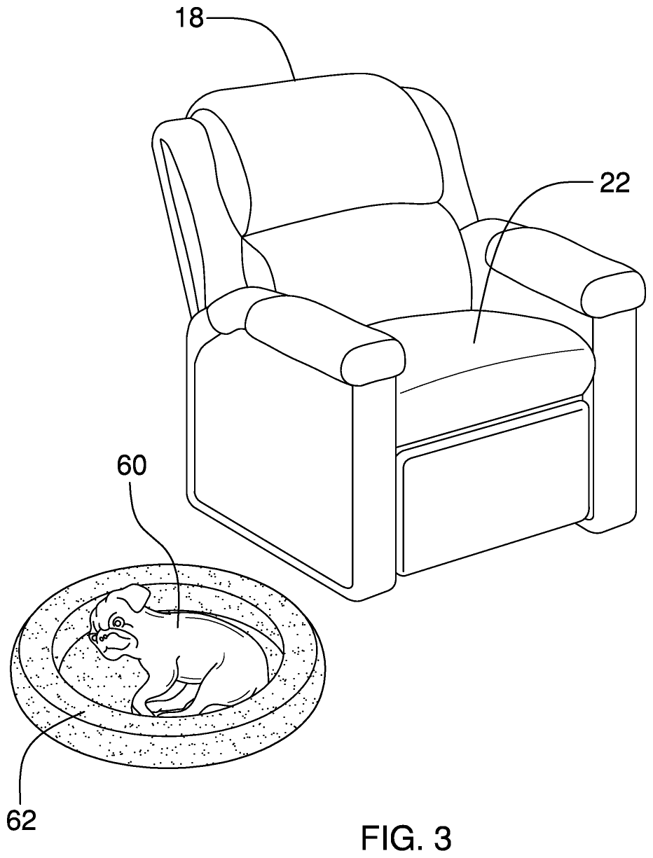

In use, the method includes bringing, for example, a household pet 60 into the room 12 to allow the household pet 60 to wonder within the room 12 and to become comfortable such that the household pet 60 associates the room with “home.” The trainer can then monitor the activity of household pet 60 both when the trainer is in the room 12, and when the trainer 60 is not within the room 12. As needed, the trainer will apply corrective teaching to the household pet 60 when the household pet engages in impermissible behavior. The corrective teaching can vary widely depending on the trainer's techniques and may also vary depending on the type of household pet, though there would usually be some variance if other types of pets aside from household pets were being trained. For some pets, a pet bed 62 may be positioned within the room 12 to be used to teach the pet to use proper behavior and lay in their pet bed 62 as shown in FIG. 3 as opposed to jumping onto the furniture as shown in FIG. 2. Once the pet has been observed for some time displaying responsible behaviors when left alone, the pet will be considered completely housetrained and thereafter safe to be left alone within an owner's actual living space.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A method for imparting behavioral modifications on a household pet, the method comprising the steps of:
placing together in a room a plurality of living space articles such that the room is defined as a faux living space, said living space articles including furniture, the room being closable such that a pet positioned within the room cannot exit the room;
bringing a household pet into said room, the household pet being allowed to wonder within the room;
monitoring activity of the household pet within the room; and
applying corrective teaching to the household pet when the household pet engages in impermissible behavior.

2. The method for imparting behavioral modifications on a household pet, according to claim 1, wherein the step of placing living space articles in the room includes said furniture comprising at least one a chair and one of a sofa configured for seating a person.

3. The method for imparting behavioral modifications on a household pet according to claim 2, further including said chair and said sofa each having an upper side comprising a fabric.

4. The method for imparting behavioral modifications on a household pet according to claim 1, wherein the step of placing living space articles in the room includes said living space articles comprising at least one table having a height being less than 24.0 inches, said living space articles including at least one rug positioned on a floor of the room, the room being closable such that an pet positioned within the room cannot exit the room.

5. The method for imparting behavioral modifications on a household pet according to claim 1, further including steps of:
placing a sectional wall in the room to divide the room into a primary space and a secondary space, said living space articles being placed in said primary space, said sectional wall having an opening therein to allow movement between said primary and secondary spaces; and
placing sleeping articles in said secondary space, said sleeping articles including a bed.

6. A method for imparting behavioral modifications on a household pet, the method comprising the steps of:
placing together in a room a plurality of living space articles such that the room is defined as a faux living space, said living space articles including furniture, said furniture comprising at least one a chair and one of a sofa configured for seating a person, said chair and said sofa each having an upper side comprising a fabric, said living space articles including at least one table having a height being less than 24.0 inches, said living space articles including at least one rug positioned on a floor of the room, the room being closable such that a pet positioned within the room cannot exit the room;
placing a sectional wall in the room to divide the room into a primary space and a secondary space, said living space articles being placed in said primary space, said sectional wall having an opening therein to allow movement between said primary and secondary spaces;
placing sleeping articles in said secondary space, said sleeping articles including a bed;
bringing a household pet into said room, the household pet being allowed to wonder within the room;
monitoring activity of the household pet within the room; and
applying corrective teaching to the household pet when the household pet engages in impermissible behavior.
